(19) United States
(12) Patent Application Publication
(10) Pub. No.: US 2008/0243777 A1
(43) Pub. Date: Oct. 2, 2008

(54) SYSTEMS AND METHODS FOR RESULTS LIST NAVIGATION USING SEMANTIC COMPONENTIAL-GRADIENT PROCESSING TECHNIQUES

(76) Inventors: Osamuyimen Thompson Stewart, Piscataway, NJ (US); Liwel Dai, Catonsville, MD (US)

Correspondence Address: Frank Chau, Esq.;F. CHAU & ASSOCIATES, LLC, 130 Woodbury Road, Woodbury, NY, 11797, US

(21) Appl. No.: 11/693,205

(22) Filed: Mar. 29, 2007

(51) Int. Cl. G06F 7/00

(52) U.S. Cl. 707/3

(57) ABSTRACT

Systems ana methods are provided for organizing and presenting large search results lists using lexical semantic componential-gradient processing techniques to dynamically organize search results into a gradable list of context rich semantic components, which is presented to a user under a gradient as a constrained set of choices to thereby facilitate user navigation of the search results.

### TECHNICAL FIELD

The present invention relates generally to systems and methods for organizing and presenting large search results lists in a way that enables efficient and search-relevant user navigation for desired information and, in particular, to systems and methods in which lexical semantic componential-gradient processing techniques are implemented to dynamically organize search results into a gradable list of context rich semantic components which is presented to a user under a gradient as a constrained set of choices to thereby facilitate user navigation of the search results.

### BACKGROUND

Various types of computer automated systems, such as electronic commerce and information retrieval systems, are supported by backend databases or data repositories which persistently store application data or other information that a user may access when interacting with the system. Depending on the application, a user query may result in the retrieval of a large amount of information from one or more backend databases, which is returned in the form of a search results list that is output according to the user interface modality of the system. For example, in speech-based systems, search results lists can be presented to the user as spoken output, whereas in GUT (graphic user interface) based systems, search results lists can be displayed on a computer monitor or a small LCD screen of a portable computing device. Depending on the user interface modality, there are practical limitations on the manner in which a large list of search results list can be presented to the user (in terms of quantity and substance) so as to allow efficient navigation of the search results list for desired information.

By way of example, in speech-based systems, the temporal nature of spoken output and the cognitive limitations on a user's short term memory pose practical limitations on the quantity of information that can be presented to a user via spoken output at a given time, as the user may not be able to remember ail possible choices of a long list. Similarly, for GUI based systems, limitations in screen space (e.g., small LCD screens on mobile phones or PDAs) pose practical limitations in the amount of information that can be presented at a given time where, for example, a user would have to scroll up and down through a long list of search results to view a long list of search results and make a desired choice. In these circumstances, it would be desirable to limit the amount of possible choices presented to a user via spoken output or as text on a small display screen at a given time so as to alleviate any cognitive burden on the user. Limiting the output to a small number of choices, however, is problematic with regard to substance. Indeed, by limiting the amount of choices presented to the user at a given time, the user may not be aware of the full scope of the search results, and thus, it may be difficult for a user to effectively navigate the search results list to find and select desired items or otherwise refine the search parameters to find a target item in relatively short time and/or limited amount of interactions.

Various techniques have been proposed to address user navigation of large results lists for speech-based interaction, for example. One conventional approach to list navigation attempts to limit the quantity of search results presented to the user at a given time by focusing primarily on a current user query/selection as the basis for refining/re-ranking search results. By way of specific example, with this approach, search results are refined/ranked using a ranking algorithm in which each new user utterance is given a weight of 1.0 while the weights of all previous utterances are reduced by a decay factor, e.g., 0.5%. This process is repeated during a list navigation session for each new user query/selection. The following user/system dialog is representative of this conventional approach to results list navigation:

System (S): Welcome to the House Hunting system. What kind of rental are you looking for?

User (U): Rent is less than $500

The system then performs a database query using the rent value as a search criterion. Assuming that the returned search results include 19 items, the initial search results are presented to the user as the highest ranked result:

(S): There is a one bedroom apartment available in the City of Provo where the rent is less than 200 a month.

(U): No, I would like a three bedroom rental.

In response, the system, refines the search using the number of bedrooms as a further search criterion. The system re-ranks value=new value=# of bedrooms, and performs a database access. Assume that the search returns 10 results, the system would play back the highest ranked result:

(S): There is a 4 bedroom apartment available in the City of Orem where the rent is 500 a month.

Although the conventional scheme (as illustrated in the above dialog) attempts to limit the quantity of results by presenting the highest ranked result, the process by which the system refines and ranks the search results is inefficient for list navigation in the context of the issues of control or substance. Indeed, the process incorrectly maps the new-old information distinction by assuming that each new utterance is an expression of the user's intent. However, each new utterance may not fully convey the user's actual intent, but may be merely an expression of some value provided by the user as a result of a lack of evidence or knowledge as to other possible choices, which the user may have otherwise selected.

In other words, the conventional approach considers the user's “uneducated” reaction to a search output as new search parameter, without informing the user about other available options or the number of options for the given list of search results, which would help the user navigate the results list and make a better selection from the list. For example, in the above exemplary dialog flow, if the user was informed that a particular search results list had only two results with the associated cost of $100 and $200, the user would be able to optimize the search in an “informed” manner by refining the search based on a higher dollar value. With the conventional approach, however, the user may likely become confused and commence a new search, resulting in tedious and unnecessarily long and unpleasant list navigation.

### SUMMARY OF THE INVENTION

Exemplary embodiments of the invention generally include systems and methods for organizing and presenting large search results lists in a way that enables efficient and search-relevant user navigation for desired information. More specifically, exemplary embodiments of the invention include systems and methods in which lexical semantic componential and gradient processing schemes are employed to dynamically partition the information space of a large list of search results into a logical structure of context sensitive semantic components that are grouped under a gradient. Lexical semantic componential processing techniques are used to dynamically organize search results into broad semantic components (categories), while lexical gradient processing techniques are used to regroup or otherwise organize the semantic components into semantically rich component categories based on gradable properties (e.g., opposite lexical relations, rank lexical relations, generic-specific relations, scalar property lexical relations, etc.), to thereby organize the search results into a gradable list of semantic components. The gradable list of semantic components is presented to the user as a list of L user-selectable semantic choices for list navigation, whereby the amount of choices L presented at any given time is constrained according to a predetermined gradient threshold N, such that L≦N.

More specifically, in one exemplary embodiment of the invention, a computer implemented process is provided for result list navigation. The method includes receiving a list of search results, processing the search results using a lexical semantic categorisation process to organise the search results into a hierarchical grouping of semantic components, processing the semantic components using a lexical semantic gradient process to organize the semantic components into a gradable list of L semantic components representative of the search results under a gradient threshold N, such that L≦N, and presenting the gradable list of semantic components to a user in the form of L component categories which may be selected by a user to navigate the search results.

These and other exemplary embodiments, aspects, features and advantages of the present invention will be described or become apparent from the following detailed description of exemplary embodiments, which is to be read in connection with the accompanying drawings.

### BRIEF DESCRIPTIONS OF THE DRAWINGS

FIG. 1 is a high-level block diagram of a system implementing semantic componential-gradient processing to support results list navigation according to an exemplary embodiment of the invention.

FIG. 2 is a flow diagram illustrating a method for providing results list navigation using semantic componential-gradient processing according to an exemplary embodiment of the invention.

FIGS. 3A-3D schematically illustrate a method for organizing and presenting search results in the form of a gradable list comprising a constrained set of user-selectable semantic categories.

### DETAILED DESCRIPTION OF EXEMPLARY EMBODIMENTS

Exemplary embodiments of systems and methods will now be described in further detail to illustrate the use of semantic componential-gradient techniques to manage and present large search results lists in a way that facilitates user navigation and selection of desired information. For illustrative purposes, exemplary results list navigation techniques will be described with reference to speech-based systems, where search results lists are dynamically organized into a gradable list of semantic components that is presented as spoken output as a constrained componential-gradient set of choices for user selection and navigation. The exemplary techniques are particularly advantageous in various user interface modalities (other than speech), for instance, in GUI where large search results lists are displayed on a screen with limited space (e.g., small LCD display of mobile phone or other portable computing device) or where a user may not be able to understand and decipher large lists of information displayed on a large screen at a given time. In such modalities, exemplary semantic componential gradient processing techniques can be used to organize and present the search results as a gradable list of context rich semantic choices that is readily displayed on a small or large screen to alleviate cognitive burden on selection of choices, while allowing efficient navigation to a target item in a short number of interactions.

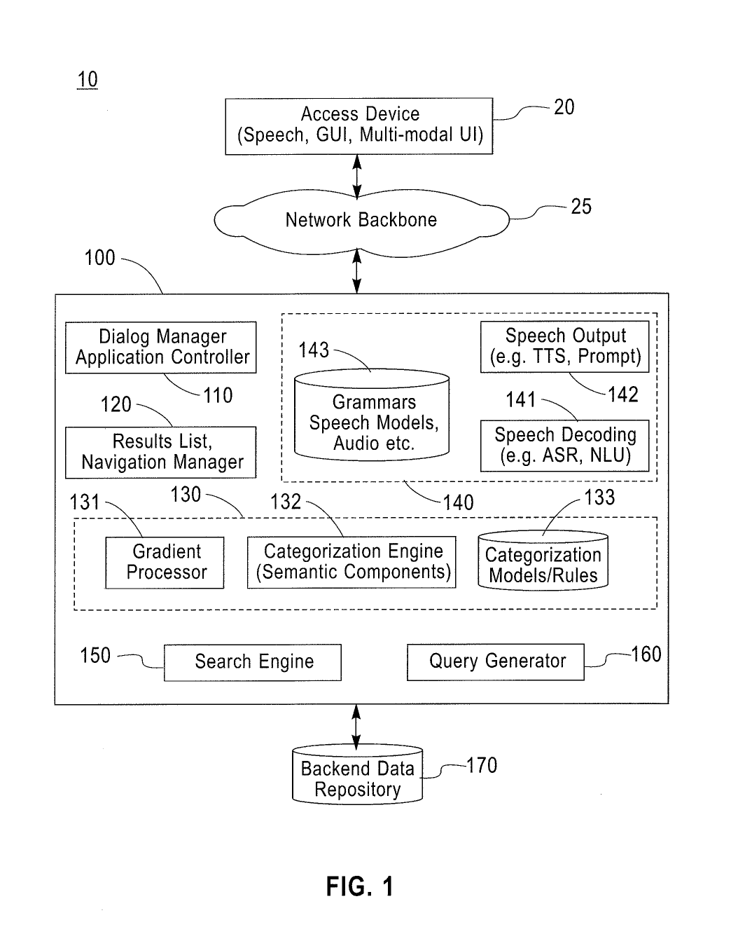

FIG. 1 is a high-level block diagram of a system implementing semantic componential-gradient processing to support results list navigation according to an exemplary embodiment of the invention. More specifically, FIG. 1 illustrates an exemplary embodiment of a client/server system (10) comprising a client access device (20) that can communicate with an application server (100) over a communications network (25). The client access device (20) may be any type of device such as PDA (personal digital assistant), mobile cell phone, standard telephone, etc., capable of communicating with the application server (100) over the communications network (e.g., LAN, WAN, Internet, PSTN, and/or wireless). The application server (100) can support various types of applications such as interactive voice response (IVR) systems, web-based electronic commerce applications, information retrieval systems, hotel searching tool, airline/train reservation tools, searching for rental apartments or homes, on-line purchasing of products/service, etc, and other types of applications in which users must navigate through large information structures to find a desired target. The application server (100) handles the business logic of the application as well as backend data accesses to one or more local/remote data sources (170) such as application backend databases or other application data repositories.

The application server (100) comprises a dialog manager (110) (application controller), results list navigation manager (120), a lexical semantics processor (130), a speech processing system (140), a search engine (150) and a query generator (160). The speech processing system (140) comprises one or more speech decoding engines (141), speech output generation engine(s) (142) and a local repository (143) of speech data/configuration files to support a spoken dialog system. The lexical semantics processor (130) includes a gradient processor (131), a semantics categorization engine (132) and a local repository (133) of categorization models/rules to support semantic componential-gradient processing of search results, as will be discussed in detail below.

In general, the dialog manager (100) manages and controls the flow of dialog and interaction between the user and application. The dialog manager controls the dialog (or sub-dialog) process based on the current dialog context (application state) and interpretation of a user command/request/query. The speech processing system (140) may be implemented to support speech-based user interface modality, where the speech decoding engines (141) may include, for example, an ASR (automatic speech recognition) to decode spoken input from a user, a NLU (natural language understanding) engine to convert natural language sentences (as decoded by the ASR) into a semantic representation of a user command within the context of the application dialog, and other speech decoding applications that are implemented for the given application (such as speaker identification engines to support biometric verification). The speech output engines (142) may include, for example, an LG (language generation) engine to generate spoken, natural language sentences, a TTS (text to speech) synthesis engine to generate spoken output, etc. The repository (143) may include various speech processing resources such as trained speech models, grammars, rules, audio files, etc., and other relevant data/configuration files that are used by speech decoding and output generation engines (141) and (142) for speech I/O processing.

The query generator (160) formulates search queries in response to system or user commands, and the search engine (150) searches and accesses relevant data from one or more data repositories (170) based on search parameters specified by the search queries. The search results are returned to the lexical semantics processor module (130) which processes the information space using semantic categorization and gradient processing techniques to dynamically organize the search results into a gradable list of semantic components, which represents the information space of the search results in a constrained set of broad semantic contexts according to a gradient. The navigation manager (120) provides an interface to allow a user to navigate the search results by presenting the gradable list of semantic components as a constrained set of user-selectable semantic categories according a predetermined gradient threshold amount N.

The semantics categorization engine (132) may implement known lexical semantic componential processing methods to filter through the information space of returned search results using semantic meta data embedded in the search results and organize the information into semantic components and sub-components based on a concept hierarchy. The semantics categorization engine (132) may operate to exhaustively partition the information space of returned search results into a hierarchical structure of semantic components (or categories) and sub-groupings (sub-categories) that are linked by shared features according to the domain semantics of the relevant application. For example, in one exemplary embodiment, the search results may be dynamically organized into a hierarchical node tree, where the nodes represent high-level, semantic concepts representative of the information contained in the search results space.

For application-specific domains, the semantics categorization engine (132) can organize a particular set of information within a specific domain into a predefined set of semantic components according to a trained taxonomic model derived/adapted according to the semantics of the domain (domain knowledge) using predefined/adaptable vocabularies (sets of categories and subcategories) to classify content, wherein relationships are indicated hierarchically. In other embodiments, where the system is a general purpose application, known methods can be implemented to categorise the content of search results into a concept hierarchy of semantic components based on programmatic evaluation of the content space according to some general domain using vocabularies that are based on common categories which are generally applicable across a wide range of domains.

The gradient processor (131) implements methods for comparing the semantic components based on gradable properties or attributes to yield more coherent semantic groupings of the semantic components and thereby organize the search results into a gradable list of semantic categories. The gradient processor (131) may implement known methods based on semantic polar/scalar opposition and summarization to organise the search results into a gradable list of semantic components according to the degree or amount to which each of the concepts possess some gradable property. For instance, the results can be grouped by comparing the degree to which the semantic components possess different properties with regard to similar components or with regard to different components. The semantic components can be organized into categories that express gradable concepts, e.g., abstract representation of measurement organized as a set of subcomponents that ordered with respect to some dimension. It is to be appreciated that gradient processing can be applied in any instance for gradable properties/attributes based on e.g., opposite lexical relations, rank lexical relations, generic-specific relations, scalar property lexical relations, etc., using known techniques.

The lexical semantic componential-gradient processing organizes the search results into a gradable list of semantic categories, which is presented to the user as a list of L user-selectable semantic choices according to a gradient threshold N, whereby the amount of choices L presented at any given time is constrained such that L≦N. The gradient threshold N can vary depending on the application interaction modality. For example, in speech based applications, the gradient threshold N can be set to 3, such that at any the search results will be presented as spoken output as a list of 3 or less semantic componential choices (or target items). In GUI interaction modalities, a list of about 10 or less semantic componential choices can be presented in a way that alleviates the cognitive burden, but for small screens N can be less than 10 to accommodate a smaller screen where all possible choices are displayable at once without scrolling.

In other exemplary embodiments of the invention, the gradient threshold N may dynamically vary in certain instances. For example, in multimodal applications where user interaction can be implemented using speech I/O and GUI I/O, the gradient threshold N can be dynamically varied to accommodate each user interface mode. By way of specific example, gradient threshold can he dynamically set according at some lower or upper limit from a constant threshold parameter M, where N=M±2, where M=5, such that for speech interaction, the gradient threshold N=5−2=3 and for GUI interaction, the gradient threshold N=5+2=7.

In view of the above, the use of semantic componential-gradient processing for results list navigation can be essentially viewed as a results list processing paradigm in which semantic component processing looks inward to the meanings of a search results output to organize the search results into a list of semantic components, whereas the gradient processing is applied to consider the total size of the output and produce a degree or rank relative to the items within the output (semantic space). The resulting nodes (semantic components) that are presented to a user are summaries of embedded sub-trees, where the nodes have semantic labels that are selected to ensure that each node is semantically rich and provides a broad characterization of the information that can be reached by selecting the node. Advantageously, this results list navigation approach allows a user to understand what is visible/reachable at/from a given node and thus, make appropriate and informed selections to reach a desired target in an optimal way. Indeed, at each point in the gradable list of semantic components, a simplified (and dynamic) summary is presented to the user so as to alleviate the cognitive burden and allow the user to focus on making a desired selection from the list being navigated. The fact that a user is empowered in this approach with knowledge of the search results at each node implies that there may, potentially, be fewer (unpleasant) navigation steps because without this knowledge, the user's decision to travel down a certain path during list navigation comes from being semantically uninformed, as in conventional navigation schemes as discussed above.

The following example is a simplified example to illustrate general concepts of using lexical semantic componential and gradient processing methods for efficient presentation and navigation of large lists of search results. By way of example, assume that in response to a user query, a search results list is returned with information pertaining to various countries, including Canada, United States, Mexico, United Kingdom, Italy, Greece, Argentina, Brazil, Chile, Australia, New Zealand and New Guinea. By applying lexical semantic componential processing, each item (country) in the search results list may be commonly grouped into a broad semantic category, COUNTRY. Further, by applying gradient processing, the items in COUNTRY can be categorized into different semantic components according to some gradable property. For instance, the list of countries can be grouped into semantic components/categories based on the Continent where the given country is located as follows:

(1) North America (United States, Canada, Mexico)

(2) South America (Argentina, Brazil, Chile)

(3) Europe (United Kingdom, Italy, Greece)

(4) Oceana (Australia, New Zealand, New Guinea).

In this regard, the search results can be presented to a. user as a set of the above four possible choices, where the search results (12 countries) are distinguish based on continent location and presented as a list of L=4 user-selectable semantic categories of Continents (North America, South America, Europe and Oceana), assuming that a predetermined gradient threshold amount N is less than or equal to 4. This allows the user to make a selection and navigate to a desired country within the set of search results (Country based on a higher level category (Continent) rather than simply list each of the countries in the set Country for user selection.

In a circumstance where N=3, the search results would not be presented as a gradable listing of 4 user-selectable semantic components based on Continents. Instead, the search list of 12 countries may he grouped according to a gradable property that distinguishes the items in the list of Countries based on the hemisphere in which each country is located as follows:

(1) Southern Hemisphere (Argentina, Brazil, Chile, Australia, New Zealand, New Guinea); and

(2) Northern Hemisphere (United States, Canada, Mexico, United Kingdom, Italy, Greece),

In this example, the search results list of countries can be presented to a user as a set of L=2 possible choices, since L does not exceed N=3. If the user selects the choice northern Hemisphere, the set of possible items (countries) in the original search results is narrowed down to 6 countries. However, given that N=3, the list of countries (L=6) in the selected component Northern Hemisphere will not be presented to the user. Instead, lexical semantic and gradient processing can be applied to the refined search result set such that the set of possible choices in Northern Hemisphere can be grouped according to Continent whereby, the refined search results for Northern Hemisphere can be presented as 2 user selectable semantic components according a gradation of different Continents in which the set of countries of the Northern Hemisphere are located, namely, (1) North America, and (2) Europe. Since each semantic category of continent includes 3 items (L=3), the items for a user-selected Continent category can be presented without further processing for user selection.

It is to be understood that the system of FIG. 1 is merely an exemplary embodiment of a speech-based system in which semantic componential-gradient processing techniques may be employed to organize, manage and present large lists of search results in a manner that facilitates user navigation of the search results lists. The systems and methods described herein may be implemented in various forms of hardware, software, firmware, special purpose processors, or a combination thereof. For example, the constituent system components can be implemented as applications comprising program instructions that are tangibly embodied on one or more program storage devices (e.g., hard disk, magnetic floppy disk, RAM, CD ROM, ROM and Flash memory) and executable by any device or machine comprising suitable architecture. It is to be further understood that since the constituent system modules and method steps depicted in the accompanying Figures may be implemented in software, the actual connections between the system components (or the flow of the process steps) may differ depending upon the manner in which the present invention is programmed. Given the teachings herein, one of ordinary skill in the related art will be able to contemplate these and similar implementations or configurations of the present invention.

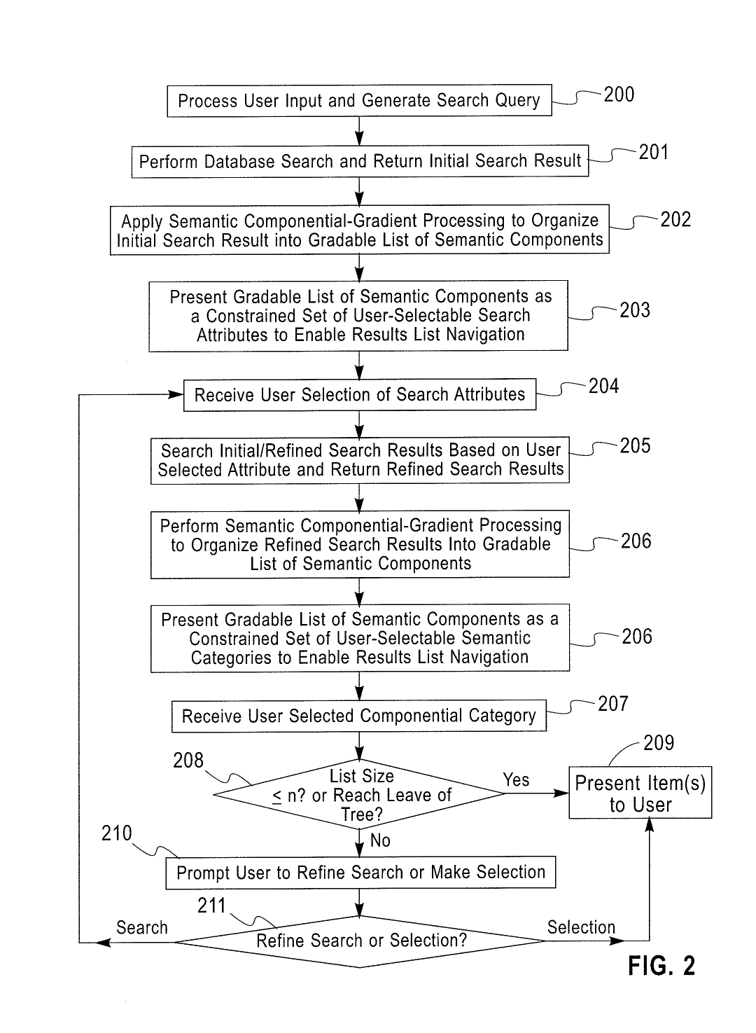

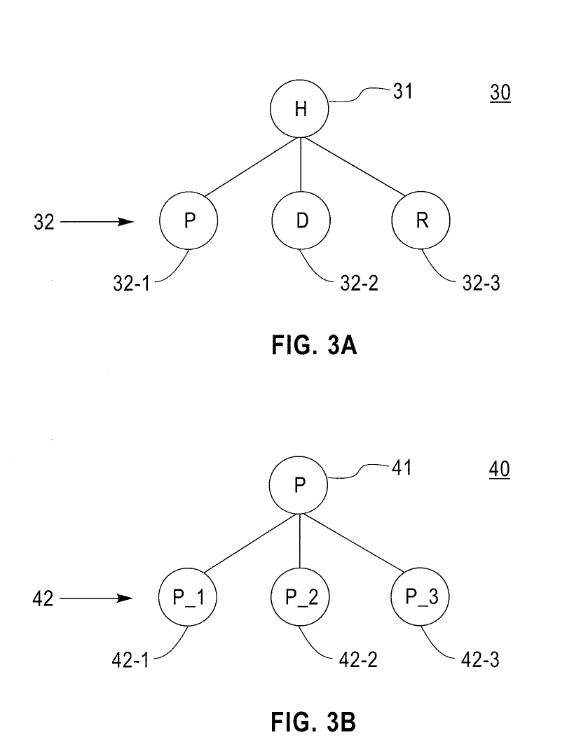

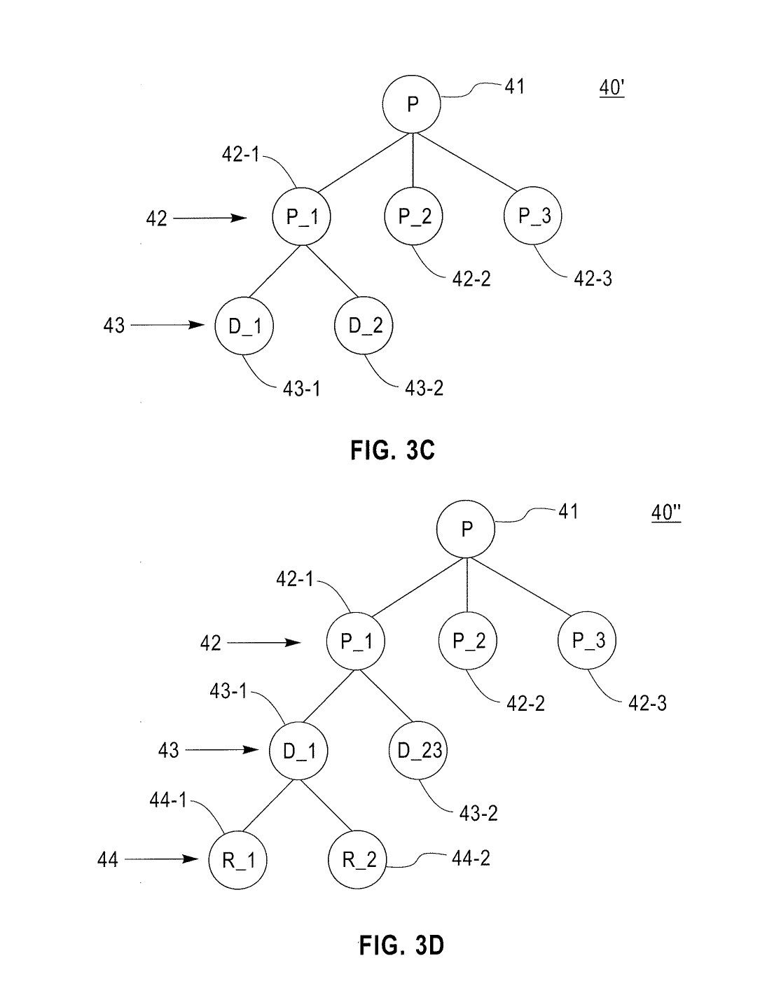

FIG. 2 is a high-level flow diagram illustrating a method for results list navigation according to an exemplary embodiment of the invention. For purposes of illustration, the exemplary embodiment of FIG. 2 will be described with reference to a speech-based search system as depicted in FIG. 1, where the application server (100) is a system that supports on-line searching of Hotel information. In addition, reference will be made to FIGS. 3A-3D which schematically illustrate methods for organizing search results into hierarchical tree structures of semantic categories at various stages of the exemplary list navigation method of FIG. 2. It is to be appreciated, however, that the exemplary systems and methods described herein can be applied in various application domains and implemented in other user interface modalities, without limitation.

The method of FIG. 2 assumes that a user session is established between the client device (20) and the application server (100) and the user initiates a search request to obtain, e.g., hotel information. The system will initially prompt the user to input some relevant information (search attributes) that is used to formulate an initial search query (step 200). The system uses the initial search query to access relevant information from one or more backend databases or data repositories and obtain initial search results (step 201). For example, the dialog between system (S) and user (U) may be as follows:

(S) Welcome to the Hotel searching Dialog system! We can pick the best hotel for you in just a few minutes. So where are you going? Please specify the name of the city and the state!

(U) Atlantic City, N.J.

(S) How long are you going to stay in Atlantic City, N.J.? Please specify the month and date of your check-in date, and check-out date!

(U) From October 2nd to October 3^{rd}.

In the above interaction, the system prompts the user for initial search attributes such as location and dates to perform an initial search for available Hotels. The search system performs speech recognition on the prompted user-input and formulates a search query based on the user-specified location and dates. For specific application domains such as Hotel searching, the initial set of search attributes acquired by the system may be predefined attributes that are selected to limit the size of the initial returned search list and to implement a specific functionality and dialog flow in the search system. Moreover, for specific domains, the relevant speech grammars can be specified for each component of the application, e.g., initial grammars (for example City and State) for the initial dialog, and components of either a closed or open set for the database covering the functionality offered by the application.

Referring to FIG. 2, the initial search results are subjected to lexical semantic-componential and gradient processing to organize the initial search results into a gradable list of semantic components (step 202). A semantic categorisation process is applied to analyze the information space of the initial search results (search result space) to partition the search result space into a hierarchical structure of semantic components according to the semantics of the domain, while a gradient process is applied to dynamically group and re-organize the semantic components and produce a gradable list of semantic components. The initial search results are presented to the user by outputting the gradable list of semantic components as a set of user-selectable search attributes (semantic categories) (step 203), wherein the user can navigate the search result list by selecting one of the attributes. The gradient processing is performed so that the number of attributes (choices of semantic categories) presented to the user is constrained so as not to exceed a predetermined gradient threshold amount N, which can vary depending on the application.

The exemplary process steps (202, 203) will be further explained by way of example, where it is assumed that the initial search results returned a list of 41 available Hotels satisfying the initial search attributes (location ana dates), and where it is assumed that semantic component and gradient processing of the initial search results produces a gradable list of semantic components which is presented by the system via spoken output as follows:

(S) There are 41 hotels available from 10/2 to 10/3. They differ in Price, Ratings, and Distance from city center. Which attribute is the most important to you, Price, Ratings or Distance?

In the above example, the initial search results are presented as a set of j items (j=41 hotels) grouped under a gradient of N=3 categories or properties such as Price (P), Rank (R) and Distance (D), which are high-level, generic semantic categories that describe distinct regions of information within the search result space. By way of specific example, FIG. 3A illustrates an exemplary hierarchical tree structure (30) representing the initial search results organized into a hierarchy of semantic components. In FIG. 3A, a root level of the tree (30) contains a root node (31) “Hotel” (H), which represents the entire search results space and which includes the entire list of initial search results. A first tree level (32) includes a plurality of child nodes (32_1, 32_2, and 32_3), which may be dynamically generated by using semantic componential-gradient to exhaustively partitioning the root node concept Hotel (H) under a gradient (N=3) into high-level, broad semantic categories such as Price (32_1), Distance (32_2), and Ratings (32_3). The child nodes (32) represent a set of generic concepts (broad semantic categories) that describe distinct regions of the semantic space of the root node H. In other words, the child nodes (32) are labeled with broad, coarse semantic categories that broadly describe basic distinguishing properties, features and/or concepts of the information space at a coarse granularity level.

In the exemplary embodiment of FIG. 3A, the semantic component-gradient processing produces a gradable list of semantic components (33) grouped under a gradient of three properties (root attributes), Price, Rating, and Distance, which are presented as a set of user-selectable search attributes to allow list navigation in distinct conceptual/lexical regions of the search results space to find a desired target. It is to be understood that the root search attributes Price, Rating, and Distance for the Hotel search system are merely used for illustrative purposes, and that the semantic categories can vary depending on the relevant application domain. Moreover, depending on the application, the root search attributes Price, Rating, and Distance may be a predefined set of semantic categories that are selected based on a priori knowledge of the relevant information space for given application domain or a set of semantic categories that are dynamically determined by programmatic evaluation of the information space of search results.

More specifically, for an application-specific domain, a predetermined set of N generic, abstract semantic concepts that broadly describe semantically distinct conceptual regions of the semantic space for the given domain. The set of N generic concepts can be considered essentially as root nodes of N distinct concept hierarchies that partition the semantic space into N distinct region, where each distinct concept hierarchy includes a set of nodes that are categorized and hierarchically organised according to a corresponding controlled vocabulary and taxonomic model. For the exemplary Hotel search application, the semantic categories Price, Distance and Ratings can be a predetermined set of N generic concepts that are selected to represent and classify relevant information within a known, structured data space.

In other exemplary embodiments of the invention, a set of N generic, abstract semantic concepts within the semantic space can be dynamically determined based on the content of the search results space. For instance, semantic componential analysis can be performed by filtering through the information of the search results space to organize the information into semantic components and sub-components based on a predefined or dynamically determined concept hierarchy. The semantic space of the initial search results includes and is defined by the entire set of semantic components. The semantic space can be exhaustively partitioned by clustering the semantic components into distinct groups of conceptually and semantically similar semantic components, where each distinct group represents/occupies a conceptually distinct, non-overlapping region of the semantic space. This process is performed based on a gradient of conceptual similarity to determine a set of N (or less) distinct generic semantic concepts that broadly describe unique and distinct properties/attributes of the information/content of the search results space, which are used to organise the initial search results into a gradable list of user-selectable search attributes to support context-specific navigation.

By way of example, FIG. 3A illustrates an example where the semantic space of the initial search results, which is represented as a root concept Hotel by root node (31), is exhaustively partitioned into a set of distinct generic semantic concepts represented by the set of nodes (32) (which are children of the root node) under a gradient of N=3 (gradient threshold). In this instance, semantic componential-gradient processing is applied to the initial search results space to exhaustively partition the entire semantic space into conceptually distinct, non overlapping regions represented, by a number of semantic categories less than or equal to the gradient threshold amount N.

Referring back to FIG. 2, after presenting the initial search results to the user (step 203) the user can select one of the n attributes to start navigating the returned results list (step 204). The dialog may proceed as follows:

(S) There are 41 hotels available from 10/2 to 10/3. They differ in Price, Ratings, and Distance from city center. Which attribute is the most Important to you, Price, Ratings or Distance?

(U) Price.

The system may process the spoken input using a grammar that is activated for the current node. The user-selected attribute (e.g., Price) is used to search the initial search results (which may be maintained as a local copy) and return a refined results list containing relevant items (step 205). The current search results are then subjected to lexical semantic-componential and gradient processing to dynamically organize the search results into a gradable list of semantic components for presentation to the user (step 206).

By way of example, continuing with the exemplary dialog and user interaction, FIG. 33 illustrates an exemplary tree structure (40) that may be generated as a result of semantic componential and gradient processing (in step 206) of the refined search results returned in response to the user's selection of the price (P) attribute. In FIG. 3B, a root tree level (41) includes a root node (R) representing a Price component P and a first tree level (42) including child nodes (42_1, 42_2, 42_3) resulting from applying gradient processing to the data space corresponding to the Price component for all Hotels (31) in the initial results list (30). The child nodes in tree level (42) are sub-components of the Price component P which group the Price data space of Hotels (included in the current results list) into different prices ranges according to a gradient.

For example, in the exemplary embodiment of FIG. 3B, the node (42_1) may represent all Hotels within, the current search results list failing within a price range of P<100 dollars per night, the node (42_2) may represent the Hotels with a price range between and including 100 and 200 dollars per night, and the node (42_3) may represent all Hotels in the current search results list falling within a price range of over 200 dollars per night. The system may present the current results list (40) as follows:

(S) Ok, There are 29 hotels below 100 dollars a night, 10 hotels between 100 to 200 dollars a night, and 2 hotels above 200 dollars a night. Which Price range do you want?

(U) Below 100 dollars.

In the exemplary dialog, the current search results list of Hotels is presented as a gradable list of N=3 subcomponents of Pricing based on a gradable concept of price range. Moreover, to add further context to the current search results list, the system identifies the number of Hotels that fall within each price range. By presenting the search results as a list of N=3 selectable components P_1, P_2, P_3, the user can navigate toward a desired target by selecting one of the choices (step 207) to further refine the search results according to the criteria—below 100 dollars per night.

Referring again to FIG. 2, when the user makes a selection for a given category (step 207), a determination is made as to whether the list size of the selected category is less than or equal to the predetermined gradient threshold N or whether the selected category can no longer be divided into a gradable list (e.g., reach leave of tree) (step 208). If either of these conditions are met (affirmative determination in step (208), the system can simply present the relevant list items to the user with no further search or navigation needed (step (209) For instance, in the above Hotel example, assume the user selects the price range P_3. Since the category P_3 includes two (L=2) Hotels (where L=N), the search system can simply present (via spoken output) the 2 choices of Hotels to the user without having to conduct further list navigation based on one or more of the remaining Banking and Distance attributes.

Moreover, depending on the state of the list navigation, the system may determine that a selected component (category) may be a leaf node whose corresponding items can no longer be subdivided under a gradient. For instance, the state of the list navigation may be such that all attributes Price, Distance and Ranking have been searched or otherwise applied such that there are no further attributes to search. In other instances, navigation may lead to a leaf node even when all attributes P, D and R have not been searched. For instance, in the above example, assume that all Hotels included in the price range P_1 (as selected by the user) have the same Ranking and Distance attribute values. In such case, a search in the P_1 Hotel list based on R or D values would not be beneficial as a gradable list of R or D values could not be generated. In such instance, the system would play back the list of Hotels falling within P_1 category (step 209).

Referring again to FIG. 2, if it is determined that neither condition in step (208) is met, the system could prompt the user to select another search attribute to further refine the search or otherwise make a selection of a current item (step 210). For instance, continuing with the above example, upon user selection of category P_1, the system may prompt the user as follows:

(S) The Hotels you selected with a price of below 100 dollars per night also differ in Ratings and Distance from city center. Please state which one is more important to you for finding a hotel, Price or Distance. If you are ready to book a hotel now, please say Yes.

In this instance, the user has an option to refine the search of Hotels falling within the price range P_1, based on Price and/or Distance attributes, if desired, or choose to have the list of Hotels in P_1 presented to the user for selection (step 211). If the user chooses to continue navigation based on another search attribute, the process continues at step 204.

In another exemplary embodiment, the system may indirectly obtain a further search attribute from interaction with the user, without actually prompting the user (as in step 211). For instance, consider the following dialog flow:

(S) Ok, There are 29 hotels below 100 dollars a night, 10 hotels between 100 to 200 dollars a night, and 2 hotels above 200 dollars a night. Which Price range do you want?

(U) Below 100 dollars.

(S): Sure. The cheapest Hotel is 39 dollars per night, Econo Lodge Atlantic City, 7.4 miles from city center and one star. Do you want to take this one?

(U): No, the Hotel is too far

In this exemplary dialog, the system presents the search results for user selection of the P_1 category with a shortcut to the cheapest Hotel in the selected price range, while providing further information regarding Distance and Rank to allow the user to make an informed decision. Based on the user response, the system can determine that the user desire to search for Hotels within the price range P_1 (Criteria 1) and which are less than 7 miles from city center.(Criteria 2: Distance less than 7 miles). In such instance, the search system can perform the steps (204˜206) by retrieving the Distance data associated with the list of Hotels falling in P_1 price range to further refine the search list. For example, continuing with the exemplary dialog:

(S) No problem, let's find you a closer hotel. There are 5 hotels within 1 mile away from the city center with price from 59 to 80 dollars per night, and 6 hotels between 1 mile to 7 miles away with a price from 55 to 83 dollars per night.

FIG. 3C illustrates the modified results list tree illustrating a third tree level (43) having child nodes 43_1 and 43_2 resulting from applying gradient processing to the data space corresponding to the Distance values of the Hotels within the price range component P_1. In the example, the gradient processing of distance information results in two sub-components D_1 and D_2 representing a gradation of distance ranges (less than 7 miles) in the data space for the Hotels of P_1, where D_1 denotes a distance within 1 mile and D_2 denotes a distance within 1 to 7 miles.

The system may then prompt the user to select one of the distance ranges:

(S) Do you want to pick a hotel within 1 mile?

(U) Yes

where the accumulated search criteria is updated to include P_1 price values and D_1 distance values. In this dialog state, the refined search results list includes five (5) Hotels with Distance and Price values falling in D_1 and P_1. As such, the system determines (in step 208) that the list size is not less than or equal to the threshold gradient g, and that D_1 is not a leaf node as the search results list of Hotels for D_1 can be further refined/graded based on the Rank attribute. Therefore, the system can prompt the user to refine the search or make a selection (step 210), For instance, an exemplary dialog flow may continue as follows:

(S) Great. Here is more information for these five hotels. Two are two-stars. One is 63 dollars a night, 0.4 miles from city center, Best Western Envoy. The other is 80 dollars a night, 0.5 miles away, Comfort Inn. Three one-star hotels, the cheapest is 59 dollars a night.

(U): I want the Best Western Envoy.

In this example, the system may assume that the higher Rank Hotels are preferred and just provide information regarding such Hotels without further processing.

Alternatively, the system can prompt the user (in step 210) as follows:

(S) The available Hotels you selected with a price of below 100 dollars per night and within 1 mile from city center also differ in Ratings. Would you like to search these hotels based on Ratings. If so, please state “search ratings” If you are ready to book a hotel now, please say Yes.

(U) Search Ratings

FIG. 3D illustrates a refined results list (40″) which may be generated by applying gradient processing to the Ranking attribute data space. In FIG. 3D, a fourth tree level (44) include subcomponents generated by semantic componential-gradient processing of the ranking data for the hotels in P_1, D_1 (1 mile) , where node R_1 represent hotels with ranking of 2 stars and R_2 represents hotels with ranking of three stars for the Hotels included in P_1 and D_1 (D within 1 mile). In FIG. 3D, the nodes 44_1 and 44_2 would be deemed leaf nodes (in step 208) since all attributes P, D and R were applied and graded.

It is to be understood that the above exemplary embodiments are illustrative of general inventive concepts for a novel results list navigation paradigm in which semantic component and gradient processing techniques are implemented to organize search results into a gradable list of semantic components under a gradient threshold amount N, which exemplary embodiments are not meant to be limiting on the scope of the invention. Indeed, one of ordinary skill in the art can readily envision other applications in which semantic component and gradient processing techniques can be applied for organising, viewing, and navigating through large information structures in such as way that allows a user to understand what is visible/reachable at/from at a given point/node in the information structure and make appropriate selections to reach a desired target item in an optimal way.

Although illustrative embodiments have been described herein with reference to the accompanying drawings, it is to be understood that the invention is not limited to the precise system, and method embodiments described herein, and that various other changes and modifications may be affected therein by one skilled in the art without departing form the scope or spirit of the invention. All such changes and modifications are intended to be included within the scope of the invention as defined by the appended claims.

We claim:

1. A computer implemented process for result list navigation, comprising:
receiving a list of search results;
processing the search results using a lexical semantic categorization process to organize the search results into a hierarchical grouping of semantic components;
processing the semantic components using a lexical semantic gradient process to organize the semantic components into a gradable list of L semantic components representative of the search results under a gradient threshold N, such that L≦H; and
presenting the gradable list of semantic components to a user in the form of L component categories which may be selected by a user to navigate the search results.

2. The method of claim 1, further comprising:
receiving as input a user selected one of the componential categories;
retrieving items of the search result list associated with the selected componential category and dynamically processing the retrieved items to produce a gradable list of semantic components representative of a refined search results list for presentation to the user.

3. The method of claim 1, further comprising:
receiving as input a user selected one of the componential categories;
retrieving items of the search result list associated with the selected componential category; and
presenting to the user each of the retrieved items corresponding to the selected componential category, if the number of retrieved items is less than or equal to N.

4. The method of claim 1, wherein the method is implemented in a speech-based system where the gradable list of semantic components is presented to a user via spoken output.

5. The method of claim 4, wherein N=3.

6. The method of claim 1, wherein the method is implemented in a constrained GUI-based system where the gradable list of semantic components is presented to a user via displayed output.

7. The method of claim 7, wherein the predetermined gradient threshold is about 10 or less.

8. The method of claim 7, wherein the gradable list of semantic components comprise N predefined search attributes that are produced from an initial list of search results for a given application domain.

9. A program storage device readable by machine, tangibly embodying a program of instructions executable by the machine to perform method steps for implementing result list navigation, the method steps comprising:
receiving a list of search results;
processing the search results using a lexical semantic categorization process to organize the search results into a hierarchical grouping of semantic components;
processing the semantic components using a lexical semantic gradient process to organize the semantic components into a gradable list of L semantic components representative of the search results under a gradient threshold N, such that L≦H; and
presenting the gradable list of semantic components to a user in the form of L component categories which may be selected by a user to navigate the search results.

10. The program storage device of claim 9, further comprising instructions for:
receiving as input a user selected one of the componential categories;
retrieving items of the search result list associated with the selected componential category and dynamically processing the retrieved items to produce a gradable list of semantic components representative of a refined search results list for presentation to the user.

11. The program storage device of claim 9, further comprising instructions for:
receiving as input a user selected one of the componential categories;
retrieving items of the search result list associated with the selected componential category; and
presenting to the user each of the retrieved items corresponding to the selected componential category, if the number of retrieved items is less than or equal to N.

12. The program storage device of claim 9, wherein the method is implemented in a speech-based system where the gradable list of semantic components is presented to a user via spoken output.

13. The program storage device of claim 12, wherein N=3.

14. The program storage device of claim 9, further comprising instructions for presenting a gradable list of semantic components to a user via constrained display output.

15. The program storage device of claim 14, wherein the predetermined gradient threshold is about 10 or less.

16. The program storage device of claim 9, wherein the gradable list of semantic components comprise N predefined search attributes that are produced from an initial list of search results for a given application domain.

17. A computer-based system, comprising:
an information access system to search and access information from one or more data sources in response to user query; and
a result list manager system to organize and present the returned search results to a user to enable result list navigation, wherein the results list manager processes the search results using a lexical semantic categorisation process to organise the search results into a hierarchical grouping of semantic components, processes the semantic components using a lexical semantic gradient process to organize the semantic components into a gradable list of L semantic components representative of the search results under a gradient threshold N, such that L≦N, and presents the gradable list of semantic components to a user in the form of L component categories which may be selected by a user to navigate the search results.

18. The system of claim 19, wherein the system is a speech-based search system.
